(19) United States
(12) Patent Application Publication
(10) Pub. No.: US 2010/0025427 A1
(43) Pub. Date: Feb. 4, 2010

(54) DUAL SUBSTANCE DISPENSER

(75) Inventors: Joe Chiou, Wilmette, IL (US); Sean Bellinger, Kenosha, WI (US); Michael Scola, Roselle, IL (US); Steve Slowik, Wheeling, IL (US)

Correspondence Address: MOORE & VAN ALLEN PLLC, P.O. BOX 13706, Research Triangle Park, NC, 27709, US

(73) Assignee: TECHNICAL CONCEPTS LLC, Mundelein, IL (US)

(21) Appl. No.: 12/506,768

(22) Filed: Jul. 21, 2009

Related U.S. Application Data
(60) Provisional application No. 61/083,524, filed on Jul. 25, 2008.

(51) Int. Cl. B67D 7/06; B67D 7/70; G04C 23/00; G04C 23/42

(52) U.S. Cl. 222/1; 222/135; 222/646; 222/649

(57) ABSTRACT

In one embodiment, at least two spray containers are used of the type having push button valves that control the delivery of spray from the containers. Each container retains a different type of spray such that activation of one container dispenses a different substance than activation of the other container. In one embodiment the substances are differentiated by their fragrances such that the substance from one container smells different than the substance from the other container. A controller controls actuation of the nozzles such that the pattern of dispensing of the different sprays may be preset. The containers can be actuated automatically in a variety of different patterns.

This application claims benefit of priority under 35 U.S.C. §119(e) to the filing date of to U.S. Provisional Application No. 61/083,524, as filed on Jul. 25, 2008, which is incorporated herein by reference in its entirety.

### FIELD OF THE INVENTION

The invention relates to dispensing systems and more particularly to a dispensing system that can dispense two different substances. Such a dispensing system may be used in public facilities and may be operated automatically.

### BACKGROUND OF THE INVENTION

Fragrance dispensers are known for dispensing fragrances, deodorizers or the like and are typically used in public facilities such as restrooms. Such dispensers typically include a container of fragrance that is automatically actuated such that the fragrance can be dispensed into the air.

### SUMMARY OF THE INVENTION

In one embodiment, at least two spray containers are used of the type having push button valves that control the delivery of spray from the containers. Each container retains a different type of spray such that activation of one container dispenses a different substance than activation of the other container. In one embodiment the substances are differentiated by their fragrances such that the substance from one container smells different than the substance from the other container. A controller controls actuation of the nozzles such that the pattern of dispensing of the different sprays may be preset. The containers can be actuated automatically in a variety of different patterns.

### BRIEF DESCRIPTION OF THE DRAWINGS

FIG. 1 is a perspective view of the dispenser of the invention.

FIG. 2 is a front view of the dispenser of FIG. 1 showing the actuating mechanism of the invention.

FIGS. 3 through 8 are perspective views of the dispenser of FIG. 1 showing the components of the dispenser.

FIG. 9 is a perspective view of the fragrance canisters and cartridge for the dispenser shown in FIG. 1.

FIG. 10 is a perspective view of the cartridge used in the dispenser of FIG. 1.

FIG. 11 is a block diagram illustrating one method of operation of the invention.

FIG. 12 is a block diagram illustrating another method of operation of the invention.

FIG. 13 is a front view of the cartridge of FIG. 10.

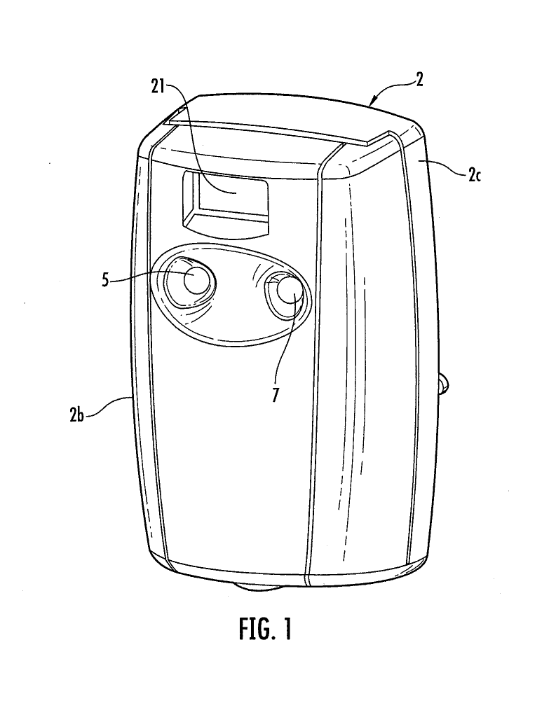

### DETAILED DESCRIPTION OF EMBODIMENTS OF THE INVENTION

In one embodiment the dispensing system of the invention comprises a housing 2 for retaining a first container 4 containing a first type of aerosol spray and a second container 6 containing a second type of aerosol spray that is different than the first type of spray. While the invention is specifically described with aerosol sprays it is to be understood that the dispenser may be used with any type of spray that can be dispensed by manipulating a valve actuator. Housing 2 has a housing back 2a that may be secured to a wall or other surface using fasteners 3, such as screws, that engage apertures 9 in the housing back 2a. Housing back 2a may support the various dispenser components as will hereinafter be described. A housing back cover 2c is secured to the housing back 2a to cover the components but leaving access to cartridge 32 and containers 4 and 6. A housing cover 2b is releasably secured to housing back 2 to cover the various dispenser components. A lock 11 attaches to the housing back 2a and releasably holds the housing cover 2b in the closed position.

Container 4 has a push button valve 8 and container 6 has a push button valve 10 for dispensing the contents of the containers. In one embodiment the substance in the containers are differentiated by their respective fragrances such that the substance from the first container 4 smells different than the substance from the second container 6. Such an arrangement fights smell fatigue that may result when a single fragrance is repeatedly dispensed in the same area.

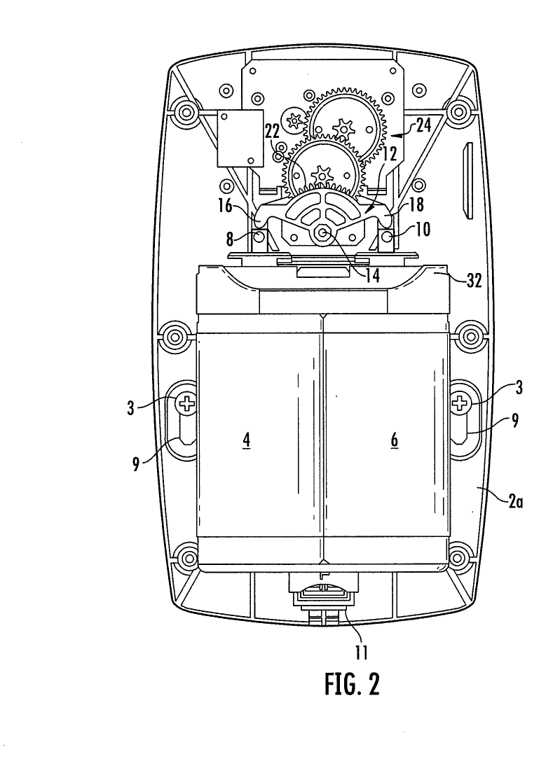

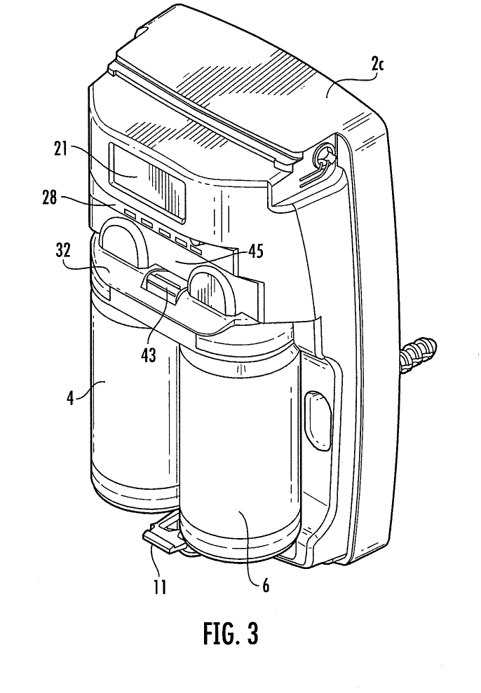

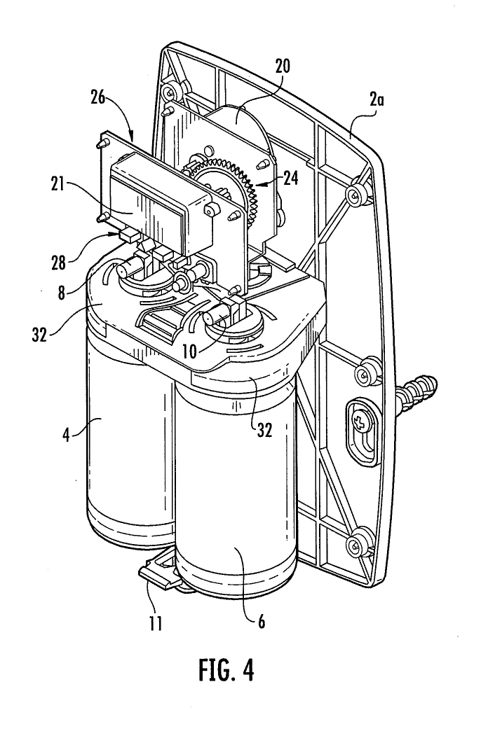

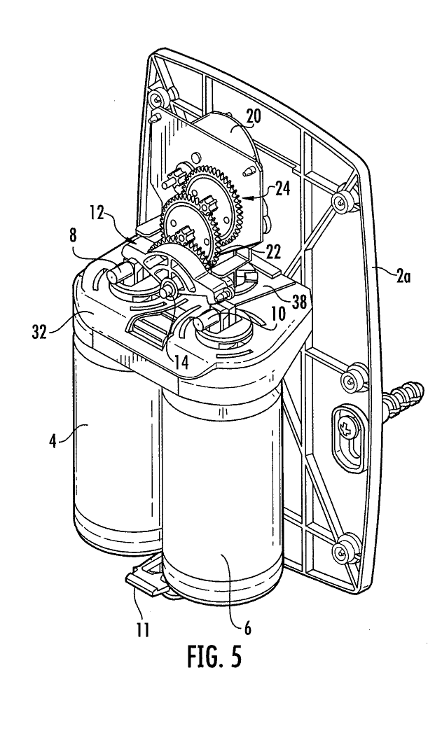

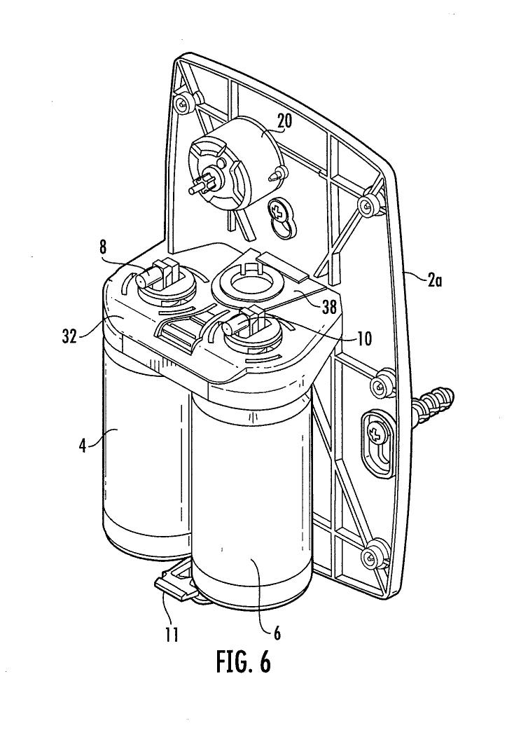

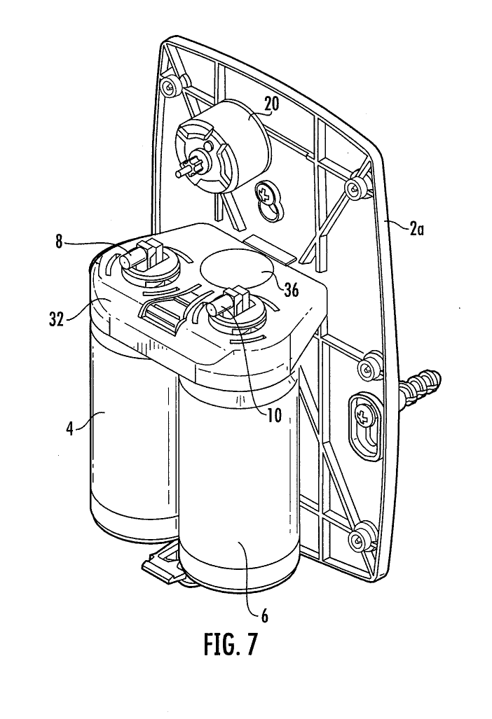

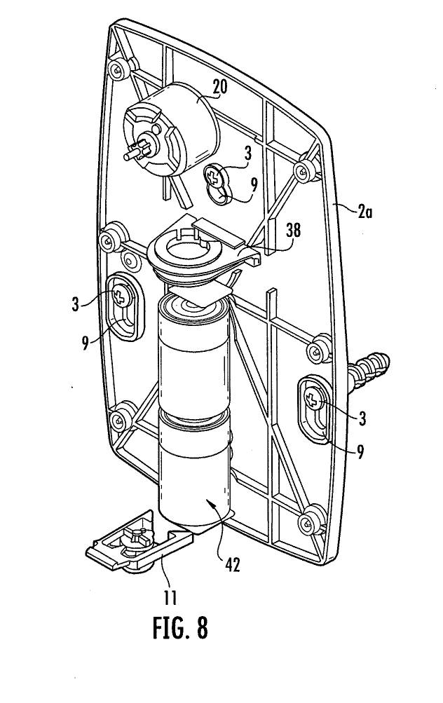

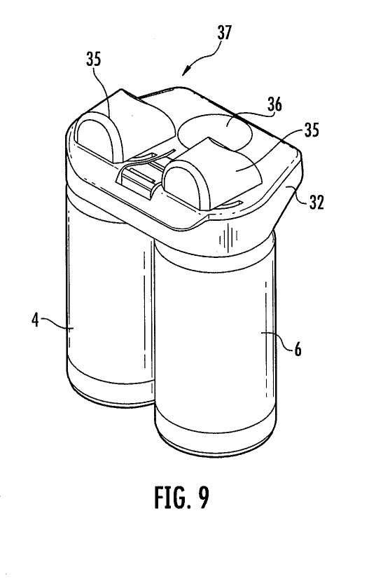

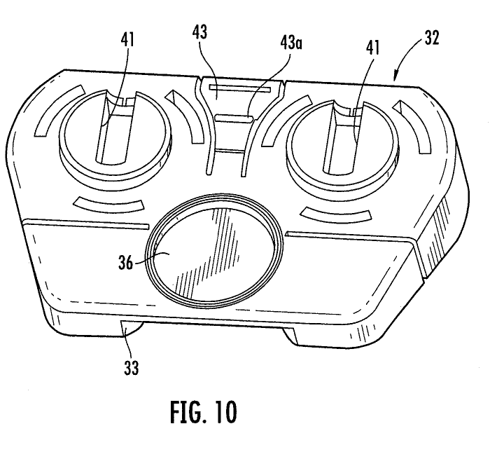

A double hammer 12 is arranged on a pivot 14 such that it can be pivoted to actuate one or the other of the containers. Hammer 12 includes a first hammer head 16 for depressing valve 8 and a second hammer head 18 for depressing valve 10. It is to be understood that when valves 8 and 10 are depressed the valves open and the contents of the containers 4 and 6 are sprayed out of apertures 5 and 7, respectively, of housing cover 2b. As viewed in FIG. 2, hammer 12 pivots counterclockwise about pivot 14 to depress valve 8 and clockwise to depress valve 10.

To pivot hammer 12, a reversible motor 20 engages a sector gear 22 formed integrally with hammer 12 through a suitable gear train 24. When motor 20 is driven in a first direction sector gear 22 rotates hammer 12 in a first direction to drive hammer head 16 into engagement with valve 8. When motor 20 is reversed and driven in a second opposite direction sector gear 22 rotates hammer 12 in a second direction to drive hammer head 18 into engagement with valve 10. The reversible motor 20 may be replaced by a reversible transmission, or other reversible drive mechanism.

To control the operation of the motor 20, a controller 26 such as a PCB controller with a LCD display 21 is used. Controller 26 may also comprise a processor or other program logic. Controller 26 controls the actuation of the motor 20 to drive the hammer 12 in a programmed pattern such that the spray is dispensed in a desired pattern. The controller 26 may control both the container that is actuated, the time interval between each actuation and the duration of each actuation. In one embodiment the containers 4 and 6 are actuated alternately although other patterns may be used. For example, the containers 4 and 6 could be actuated such that one container is emptied before the second container is actuated. The containers may alternate in a day mode or a half day mode. In the day mode the containers 4 and 6 are alternated every day and in the half day mode the containers 4 and 6 are alternated every portion of a day (e.g. every half day). The user may also select the length of a “day”. For example, a day may be 8, 12,16 or 24 hours. The containers 4 and 6 may also be alternated hourly. The user may also select the number of days to completion, i.e. until the containers are empty. For example, the user may select 60, 90, 120 or 180 days until completion. The controller 26, based on the length of the “day”, and the mode of operation can determine the frequency of actuation of the containers. The duration of each actuation is controlled by controlling the length of time hammer 12 depresses each valve. A user interface 28 such as push buttons or a keyboard may be provided to input user data to the controller 26 allow the time interval and pattern to be set and/or changed by the user.

The system may be powered by a portable, removable battery pack 42. Alternatively, the battery pack 42 may be replaced by a permanent source of current such as a plug to a wall socket or hard wiring to an electric grid.

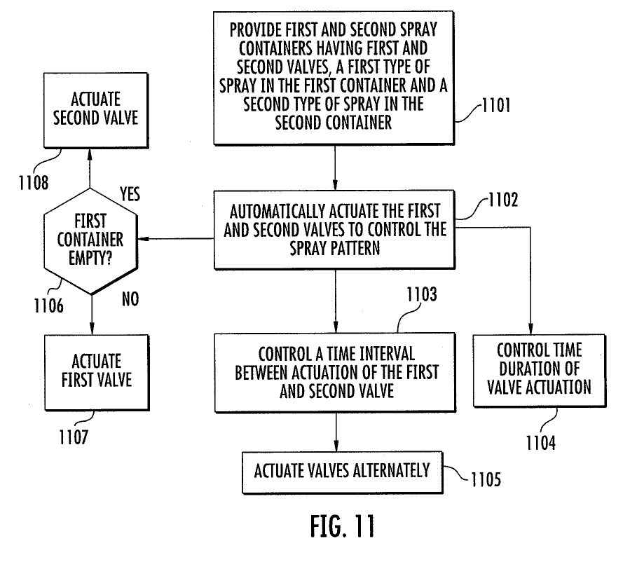

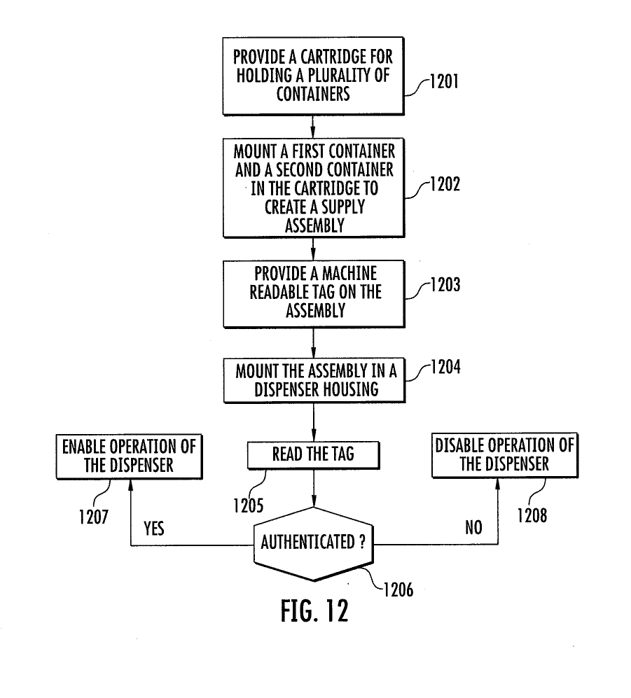

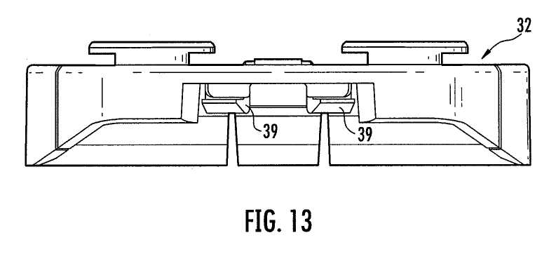

Referring to FIG. 11, a method of operating a dispenser comprises providing at least a first spray container 4 having a first valve 8 and a second spray container 6 having a second valve 10 where a first type of spray is in the first container and a second type of spray is in the second container, block 1101. The first valve 8 and the second valve 10 are selectively and automatically actuated to control the pattern of actuation of the first and second valves and the pattern of spray, block 1102. The valves are actuated to control a time interval between actuation of the first valve and second valve, block 1103. The valves are also actuated to control the duration of the valve actuation, block 1104. The first valve and second valve may be actuated alternately, block 1105, including the containers may be alternated every 24 hours or a portion of 24 hours. The second container may be actuated only if the first container is empty. A determination is made if the first container is empty, block 1106. If the first container is not empty, the first valve is actuated, block 1107. If the first container is empty, the second valve is actuated, block 1108.

The containers 4 and 6 may be replaced individually or the replacements may be provided as a two can set where the two containers are joined together by a cartridge 32 that is used to hold the containers in the proper orientation. The two containers joined by the cartridge 32 create a supply assembly 37. Cartridge 32 includes flexible fingers 39 that extend from the bottom of the cartridge and engage a rim or flange on containers 4 and 6 with the nozzles 8 and 10 extending through apertures 41. The supply assembly 37 can be removed from the housing 2 in a single operation when the containers are empty and the new refill containers can be inserted in the housing in a single operation. The cartridge includes a locking member 43 that engages a portion 45 of the housing to lock the cartridge in the housing. The locking member 43 is biased into engagement with housing portion 45 and can be depressed to release the housing and unlock the cartridge from the housing. The locking member 43 may be formed integrally with the cartridge and moved between the locked and unlocked position by deforming the member and using the resiliency of the member to return it to the locked position. The locking member 43 may include ridges 43a or other structure to engaging housing portion 45. The cartridge 32 may include a mechanical receptacle 33 that engages a mating key on the housing to ensure that the cartridge 32 and replacement containers are properly positioned in the housing. The receptacle and key may be reversed with the receptacle on the housing and the key on the cartridge 32. The valves 8 and 10 may be covered by removable covers 35 during transportation and insertion of the assembly into the housing to prevent the valves from being inadvertently depressed and accidentally dispensing spray. The covers 35 are removed to allow access to the valves 8 and 10 during use.

An electronic machine readable tag 36 such as an RFID tag may be provided on the refills that can be read by a sensor 38 such as an RFID transmitter/receiver.

In the illustrated embodiment tag 36 is located on cartridge 32 and is inserted into the transmitter/receiver 38 when the cartridge is properly positioned in housing 2. A signal from sensor 38 is transmitted to the controller 26 to control operation of the dispenser. The tag 36 may be used for inventory control. For example the controller may track the life cycle of the containers, the number or type of containers used or the like. The tag 36 may also be used for security purposes to ensure that only compatible refills are used in the system. The tag may contain a code such as a serial number that is transmitted by sensor 38 to the controller 26. The code can be read by the controller 26 to authenticate the supply assembly 37. The system may be deactivated if a non-compatible refill is installed, i.e. if the code is not recognized by the controller. Operation of the dispenser may only be enabled if the code is authenticated.

A method of operating a dispenser comprises providing a cartridge 32 for holding a plurality of containers, block 1201. In the illustrated embodiment two containers are provided although a greater number of containers and different types of sprays may be used. At least a first container 4 and a second container 6 are mounted in the cartridge 32 to create a supply assembly 37, block 1202. An electronic machine readable tag 36 is provided on the assembly 37, block 1203. The assembly 37 is mounted in a dispenser housing 2, block 1204. The electronic tag 36 is read by a sensor 38, block 1205. The tag is then authenticated, block 1206. Operation of the dispenser is enabled if the electronic tag 36 is recognized as being authentic, block 1207. If the electronic tag is not authenticated operation of the dispenser may be disabled, block 1208.

Specific embodiments of an invention are disclosed herein. One of ordinary skill in the art will recognize that the invention has other applications in other environments. Many embodiments are possible. The following claims are in no way intended to limit the scope of the invention to the specific embodiments described above.

1. A dispensing system comprising:
a first spray container having a first valve and a second spray container having a second valve;
a first type of spray in the first container and a second type of spray in the second container;
an actuator for selectively actuating the first valve or the second valve;
a controller for controlling the actuator to control the pattern of actuation of the first and second valves.

2. The dispensing system of claim 1 wherein the first valve and second valve are push button valves.

3. The dispensing system of claim 1 wherein said first type of spray has a first fragrance.

4. The dispensing system of claim 3 wherein said second type of spray has a second fragrance.

5. The dispensing system of claim 1 wherein the actuator comprises a hammer arranged on a pivot such that the hammer can be pivoted to actuate the first valve and the second valve.

6. The dispensing system of claim 4 wherein said hammer includes a first hammer head for depressing said first valve and a second hammer head for depressing said second valve.

7. The dispensing system of claim 1 wherein said actuator is moved by a reversible motor.

8. The dispensing system of claim 5 wherein said hammer is formed with a sector gear that is driven by a reversible motor.

9. The dispensing system of claim 7 wherein said motor is controlled by a controller.

10. The dispensing system of claim 9 wherein said controller is a PCB controller.

11. The dispensing system of claim 9 wherein said controller is a processor.

12. The dispensing system of claim 9 wherein said controller actuates the motor to drive the hammer in a programmed pattern such that the spray is dispensed in a desired pattern.

13. The dispensing system of claim 12 wherein the controller controls the motor to control a time interval between actuation of the first valve and second valve.

14. The dispensing system of claim 9 wherein the first valve and second valve are actuated alternately.

15. The dispensing system of claim 9 wherein the first container is empty before the second container is actuated.

16. The dispensing system of claim 9 wherein the containers are alternated every 24 hours.

17. The dispensing system of claim 9 wherein the containers are alternated a portion of 24 hours.

18. The dispensing system of claim 9 wherein the containers are alternated every 8 hours.

19. The dispensing system of claim 1 a user interface operatively connected to the controller to program the controller.

20. The dispensing system of claim 1 wherein said actuator is powered by a battery pack.

21. The dispensing system of claim 1 wherein the first container and second container are removably mounted in the system.

22. The dispensing system of claim 21 wherein first container and second container are joined together by a cartridge that holds the containers in the proper orientation.

23. The dispensing system of claim 22 wherein the cartridge and first container and second container are joined as an assembly.

24. The dispensing system of claim 22 wherein the cartridge includes a mechanical key that engages a mating receptacle on a housing to ensure that the assembly is properly positioned in the housing.

25. The dispensing system of claim 22 further including a tag on the assembly that can be read by a sensor.

26. The dispensing system of claim 1 wherein the first type of spray and the second type of spray are aerosols.

27. A cartridge assembly for use in a dispenser comprising:
a cartridge for holding a plurality of containers together as a unit;
a first container held by the cartridge;
a second container held by the cartridge; and
a electronic tag identifying the assembly.

28. The cartridge assembly of claim 27 wherein said cartridge includes a mechanical key.

29. The cartridge assembly of claim 27 wherein a first type of aerosol spray is in the first container and a second type of aerosol spray is in the second container.

30. The cartridge assembly of claim 29 wherein said first type of aerosol spray has a first fragrance and said second type of aerosol spray has a second fragrance.

31. A method of operating a dispenser comprising;
providing a cartridge for holding a plurality of containers together as a unit;
mounting a first container and a second container in said cartridge to create an assembly;
providing an electronic tag identifying the assembly;
mounting said assembly in a dispenser housing;
reading the electronic tag; and
enabling operation of the dispenser if the electronic tag is authorized.

32. A method of operating a dispenser comprising; providing a first aerosol spray container having a first valve and a second aerosol spray container having a second valve where a first type of aerosol spray is in the first container and a second type of aerosol spray is in the second container;
selectively actuating the first valve or the second valve to control the pattern of actuation of the first and second valves.

33. The method of claim 32 wherein the valves are actuated to control a time interval between actuation of the first valve and second valve.

34. The method of claim 32 wherein the first valve and second valve are actuated alternately.

35. The method of claim 32 wherein the first container is empty before the second container is actuated.

36. The method of claim 32 wherein the containers are alternated every 24 hours.

37. The method of claim 32 wherein the containers are alternated a portion of 24 hours.

38. The method of claim 32 wherein the containers are alternated every 8 hours.
